(19) United States
(12) Patent Application Publication
(10) Pub. No.: US 2013/0006673 A1
(43) Pub. Date: Jan. 3, 2013

(54) Consolidating Billing Statements in an Agency Business Model

(75) Inventors: Patricia Hurston, Chicago, IL (US); Marina Krevenya, Chicago, IL (US); Daniel R. Cox, Wheaton, IL (US)

(73) Assignee: CONTINENTAL CASUALTY COMPANY, Chicago, IL (US)

(21) Appl. No.: 13/172,760

(22) Filed: Jun. 29, 2011

(51) Int. Cl. G06Q 40/00

(52) U.S. Cl. 705/4

(57) ABSTRACT

A customer-focused, web-based computer system and methods may put the agency and the agency/broker code's perspective into billing, collections, and cash application processes. The system and methods may also allow a carrier to manage relationships with agents while including linkage to policy documents, a consolidated agency/broker code bill and commission presentment, online account reconciliation, and automated payment application. Furthermore, the methods may provide an agent user with access to data and functions that allow the system to consolidate an agency's multiple agency/broker code invoices into a single invoice for the entire agency or multiple groupings that align with the agency's accounting needs.

### FIELD OF TECHNOLOGY

The present disclosure relates generally to management of billing statements for an insurance entity using an agency business model and more specifically to a system and a method for consolidating branch and producer billing statements for an insurance entity using an agency business model.

### BACKGROUND

The background description provided herein is for the purpose of generally presenting the context of the disclosure. Work of the presently named applicant, to the extent it is described in this background section, as well as aspects of the description that may not otherwise qualify as prior art at the time of filing, are neither expressly nor impliedly admitted as prior art against the present disclosure.

Insurance carriers often employ a business model through which products are distributed to customers by agencies and brokers. Producers are either agencies themselves or individuals within the agencies. Each producer or agency is licensed by the insurance carrier to sell insurance products and may also include one or more branches that include physical storefront locations or regions or for a specific business segment (e.g., small business, middle markets, specialty lines, etc.).

Insurance carriers and agencies have grown and consolidated over time. Each business entity may have many agency/broker codes for various reasons including differentiation among business segments and business lines (e.g., commercial, large property, specialty lines such as auto, boat, health, etc.), agency mergers, each agency's internal business segmentation, etc. Growth and consolidation has complicated the billing process that originates from the carrier through agent/broker to the policyholder. As the businesses have expanded, the agent/broker have merged with other branches and producers or split according to typical business practices. Throughout these many changes in business entity, each agent/broker maintains the original relationship with the insurance carrier. Billing from the insurance carrier for their products is typically organized around a combination of business lines, business segments and/or physical location identified by agency/broker code and the insurance carrier may produce bills for each agency/broker code. As mergers and other entity changes have increased in complexity over time, billing statements have also become increasingly complex, resulting in confusion and delays in the billing process.

### SUMMARY

The features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

A computer-implemented method or instructions stored on a tangible computer-readable medium for consolidating an insurance agency/broker's multiple invoices into one invoice for the agency may receive login data including agency permissions to access billing data corresponding to a plurality of agency/broker codes for the agency. The method or instructions may also receive consolidation data corresponding to at least one of the agency/broker codes, the consolidation data indicating which of the plurality of agency/broker codes to include on a consolidated agency invoice. Additionally, the method or instructions may retrieve billing data corresponding to the indicated agencies/brokers from the consolidation data, format, and present the retrieved billing data in the consolidate agency invoice.

The retrieved billing data may include a plurality of insured corresponding to each of the plurality of agency/broker codes. Presenting the retrieved billing data in the consolidated agency invoice may includes presenting a selectable graphic element to view one or more of payment history, cancellation information, dispute items, and contact information corresponding to the retrieved billing data. The billing data corresponding to the brokers of the agency may be presented within a web browser in response to receiving the login data at a backend server hosting the system. Formatting and presenting the retrieved billing data in the consolidated agency invoice may include generating one or more of a web page including the retrieved billing data or a paper invoice including the retrieved billing data. The web page for the consolidated agency invoice may include instructions that allow a user to retrieve and display data for viewing and paying a bill, for revising and paying a pending payment, and for deleting a pending payment.

The method or instructions may also compare a payment amount and an amount due corresponding to the consolidated agency invoice to determine a discrepancy. An exceptions and omissions web page may be presented via the web browser in response to determining the discrepancy between the payment amount and the amount due corresponding to the consolidated agency invoice.

A computer system for consolidating an insurance agency's multiple agency/broker code invoices into one invoice for the agency may comprise a web portal, an accounts receivable repository, and an agency bill pay module. The web portal may be executable by a server and configured to receive login data from a web browser over a network connection. The login data may include agency permissions to access billing data corresponding to a plurality of agency/broker codes for the agency. The billing and commission data repository may be in communication with the server and store the billing data corresponding to the plurality of agency/broker codes for the agency. The agency bill pay module may be executable by the server and configured to receive consolidation data via the web portal. The consolidation data may correspond to at least one of the agency/broker codes and indicate which of the plurality of agency/broker codes to include on a consolidated agency invoice. The agency bill pay module may also be configured to retrieve billing data corresponding to the indicated agency/broker codes from the consolidation data, format the retrieved billing data in the consolidated agency invoice, and present the consolidated agency invoice on the web browser via the network connection.

As with the method or instructions described above, the billing data retrieved by the agency bill pay module may include a plurality of insured corresponding to each of the plurality of agency/broker codes. The consolidated agency invoice may include one or more selectable graphic elements to present one or more of payment history, cancellation information, imaged policy documents, dispute items, and contact information corresponding to the retrieved billing data on the web browser via the network connection.

The agency bill pay module may be further configured to generate one or more of a web page including the retrieved billing data as the consolidated agency invoice or a paper invoice including the retrieved billing data as the consolidated agency invoice. The web page for the consolidated agency invoice may include a selectable graphic element that allows a user to retrieve and display data for viewing and paying a bill, for revising and paying a pending payment, and for deleting a pending payment, and the data corresponds to the retrieved billing data. The agency bill pay module may be still further configured to compare a payment amount and an amount due corresponding to the consolidated agency invoice to determine a discrepancy. This discrepancy may then be used to retrieve and present an exceptions and omissions web page on the browser via the network connection in response to determining the discrepancy between the payment amount and the amount due corresponding to the consolidated agency invoice.

### BRIEF DESCRIPTION OF THE DRAWINGS

FIG. 1 is a high-level block diagram of a system for consolidating billing statements for an insurance entity that uses an agency business model;

FIG. 2 is a high-level block diagram of one example of a billing process for an insurance entity using an agency model;

FIG. 3 is a high-level block diagram of another example of a billing process for an insurance entity using an agency model;

FIG. 4 is an exemplary flow chart of one method for consolidating an agency's multiple agency/broker code invoices into one invoice for the agency or multiple groupings;

FIG. 5 is an exemplary web page including a billing summary;

FIG. 6 is an exemplary web page including billing details;

FIG. 7 is an exemplary web page including agency commissions;

FIG. 8 is an exemplary web page including policy cancellations;

FIG. 9 is an exemplary web page including disputed items;

FIG. 10 is an exemplary web page including payment history;

FIG. 11 is an exemplary web page including an administration page;

FIG. 12 is an exemplary flow chart of another method for consolidating an agency's multiple agency/broker code invoices into one invoice for the agency or multiple groupings;

FIG. 13 is an exemplary web page including a first pay bill page;

FIG. 14 is an exemplary web page including a payment entry option page;

FIG. 15 is an exemplary web page including a view account summary page;

FIG. 16 is an exemplary web page including an exceptions and omissions page;

FIG. 17 is an exemplary web page including a select payment method page;

FIG. 18 is an exemplary web page including a review payment instructions page;

FIG. 19 is an exemplary web page including a view confirmation page; and

FIG. 20 is high-level block diagram of a computing environment that implements a system and method for consolidating an agency's multiple agency/broker code invoices into one invoice for the agency or multiple groupings.

The figures depict a preferred embodiment for purposes of illustration only. One skilled in the art will readily recognize from the following discussion that alternative embodiments of the structures and methods illustrated herein may be employed without departing from the principles described herein.

### DETAILED DESCRIPTION

A customer-focused, web-based computer system and methods may put the agency and the agency/broker code's perspective into billing, collections, and cash application processes. The system and methods may also allow the carrier to manage relationships with agencies and agents while including linkage to policy documents, a consolidated agency/broker code bill and commission presentment, online account reconciliation, and automated payment application. The system and methods may also reduce paper-based transactions.

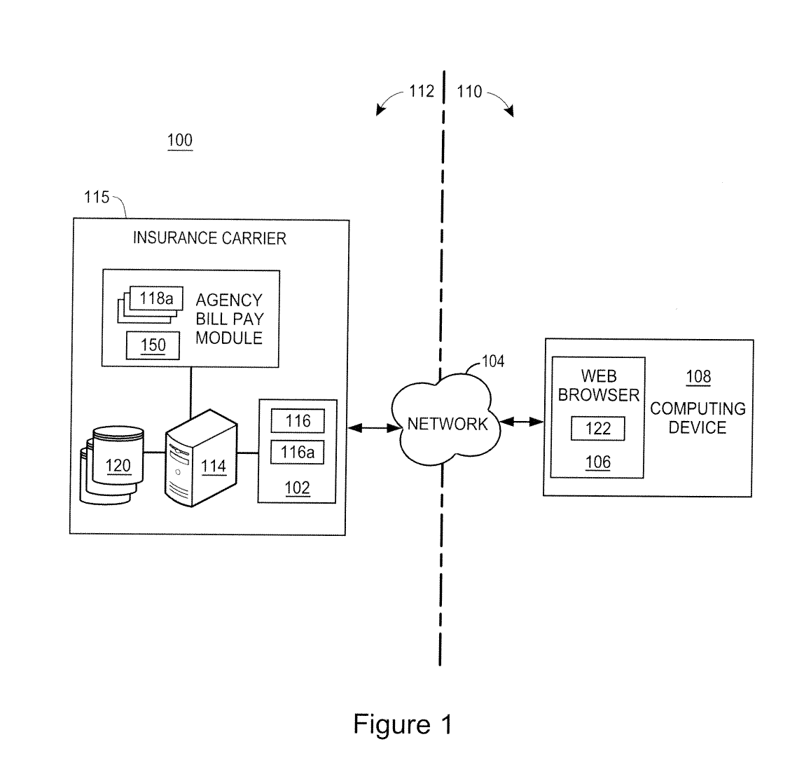

FIG. 1 is a high-level block diagram that illustrates a system 100 for consolidating billing, policy, billing dispute and reconciliation, payment, transaction document retrieval, and collections information within a single web portal or website 102 that is accessible by an agent and other system users via a network 104 on a browser 106 of a user computing device 108. The high-level architecture includes both hardware and software applications, as well as various data communications channels for communicating data between the various hardware and software components. The system 100 may be roughly divided into front-end components 110 and back-end components 112 communicating via a network 106. The website 102 may be hosted on a server 114 within an insurance carrier data system 115 and include access to several data resources and modules. A module may include one or more functions or routines in the form of computer-executable instructions that are stored in a tangible computer-readable medium and executed using a processor of a computing device (e.g., personal computer, a smart phone, tablet computer, a mobile computing device, or other personal computing device, as described herein).

The insurance carrier website 102 may include an agent center 116 webpage that requires entry of login data 116a that is received by the server 110. The login data 116a may allow an agent or other user to interface with the system 100. The login data 116a may include agency permissions that define access to data corresponding to the plurality of agency/broker codes for that agency. The agent center website 102 may include several functions that allow a user to initiate various tasks that are executed by the system 100. In some embodiments, the agent center webpage 116 includes a home tab for displaying general information, a sales and marketing tab that may include access to sales and marketing materials for the agent use, a learning tab to initiate access to another webpage with information about different products and instruction offerings from the insurance carrier. A bill tab may initiate access to an agency bill pay module 118 that provides an agent user with access to data and functions that allow the system 100 to consolidate an agency's multiple agency/broker code invoices into a single invoice for the entire agency or multiple groupings (i.e., “consolidations”) that align with the agency's accounting needs as well as view documents and data related to transactions within the single invoice and initiate reconciliation and exception processing for the invoices.

To provide needed data and functions to perform consolidation tasks, the agency bill pay module 118 may be in communication with multiple other data repositories, modules, and outputs of the system 100. The module 118 may include formatting data within a repository for headings, graphics, descriptive text, and other formatting information for the various web pages of the website 102, as described below. The agency bill pay module 118 may also include one or more functions 118a that manipulate data and other functions from a plurality of data sources 120 when called from a user interface of the website 102. For example, the functions 118a may consolidate multiple selected agency/broker code invoices into a single invoice for a corresponding agency or multiple groupings (consolidations) that align with the agency's accounting needs, allow a user to view account information, reconcile discrepancies within invoices (e.g., download, edit, and upload billing information and invoices), view policies and other documentation associated with an account, provide various payment options, initiate and continue an invoice dispute, etc. In some embodiments, a function 118a includes instructions to retrieve selected billing data from a billing and commissions data repository 120 of the Insurance Carrier data system 115. The retrieved data may correspond to agency/broker codes selected by the user from a user interface of the website 102 displayed within the web browser 106.

The system 115 may also include other modules such as a login module that processes login data 116a for external data and permissions for users (e.g., access to Sales and Marketing data, Billing data, etc.) and agency/broker code cross references with permissions defining which data may be accessed by a user. Another module may include data and functions to produce a portable data file (.pdf) or other type of “paper” invoice using the data and functions of the agency bill pay module 118. An invoice access module may include data and functions to store and retrieve invoices and other documents produced by other modules of the system and provide the invoices and documents to the agency bill pay module 118. Another module may include data and functions to provide a user with results from the agency bill pay module 118 or other modules in spreadsheet format (e.g., Microsoft Excel® or other format, etc.). Further modules may be used internally by the system 115 to provide collections information for a collections department and for various functions 118a that initiate and resolve billing discrepancies with a user.

The agency bill pay module 118 may produce a consolidated statement 122 from various data and functions of the system 100. In some embodiments, the statement 122 may consolidate multiple agency/broker code invoices of an agency. The system 115 may also communicate with a bank. Using an Automated Clearing House (ACH)/Electronic Funds Transfer (ETF) connection, the bank may receive payments from users to the insurance carrier hosting the website 102. A payment file may be transferred from the bank once a user of the system 100 completes a payment through the agency bill pay module 114.

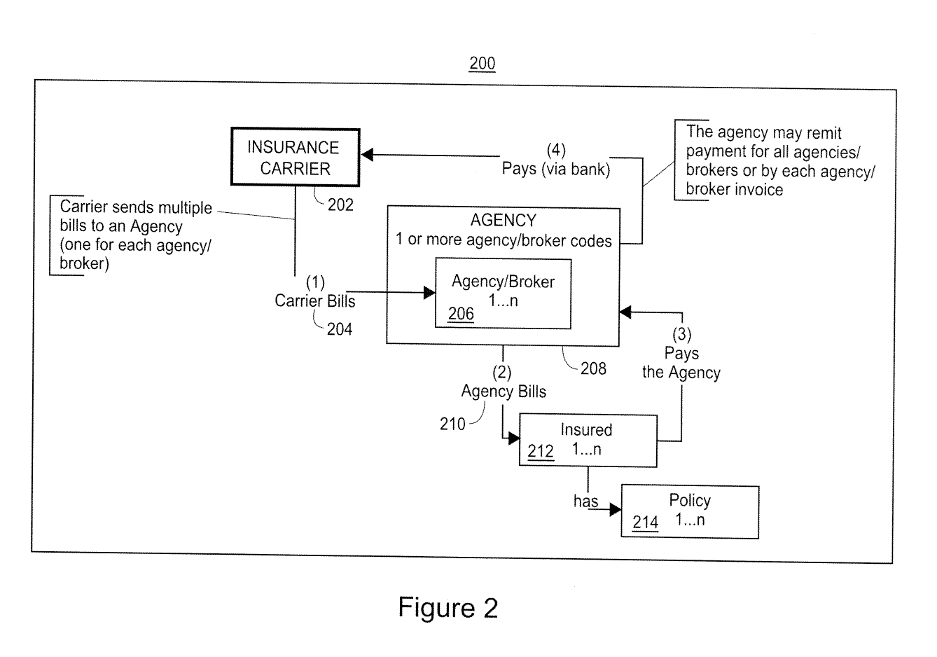

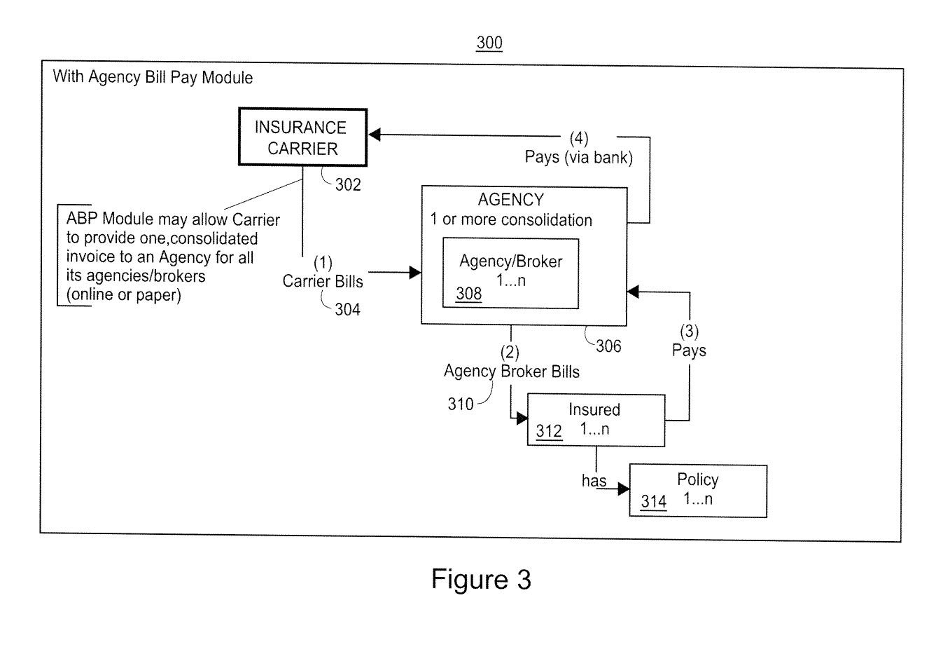

FIGS. 2 and 3 illustrate embodiments of process flows for producing invoices and receiving payments in an agency-based business model. With reference to FIG. 2, one process embodiment 200 may employ some components of the system 100 (FIG. 1) for billing. An insurance carrier 202 may produce an invoice 204 for each agency/broker code 206 within an agency 208. Because each agency often includes many agency/broker codes 206, the carrier 202 may send many invoices 204 to an agency 208. The agency 208 may then separate the invoices 204 to produce another invoice 210 for each policyholder or insured 212 that may each have many policies 214. Each insured 212 may then pay the agency 208 for the received invoice 210 and each agency 208 may then pay the carrier 202 via an electronic bank transaction. The agency 208 may remit payment for all agency/broker codes 206 within the agency 208, or by each individual agency/broker code invoice 204. Thus, using the first process 200, a carrier 202 may produce an invoice 204 for each agency/broker code 206 within an agency.

With reference to FIG. 3, another process embodiment 300 may employ the system 100 including the website 102 and Agency Bill Pay module 118 to manage billing. An insurance carrier 302 may produce a consolidated agency invoice 304 for the agency 306. In some embodiments, the agency bill pay module 118 includes instructions that, when executed by a computing device of the system 100, consolidate the many invoices for each agency/broker code 308 (as described above in relation to FIG. 2) into a single invoice 304 for the agency 306. The agency 306 may then provide a consolidated insured invoice 301 for each insured 312 that may each have many policies 314. Each insured 312 may then pay the agency 306 for the received consolidated insured invoice 310 and each agency 306 may then pay the carrier 302 via an electronic bank transaction. The agency bill pay module 118 may also include instructions that, when executed by a computing device of the system 100, allow the agency 306 to remit payment for an entire agency 306. Thus, using the second process 300, a carrier 302 may produce a single, consolidated agency invoice 304 for each agency 306. The system 100 may automatically associate multiples types of payments received from agents and brokers (e.g., checks, wires, ach, online submission, etc.) to the payment details submitted in the Pay Bill screen, as described, below.

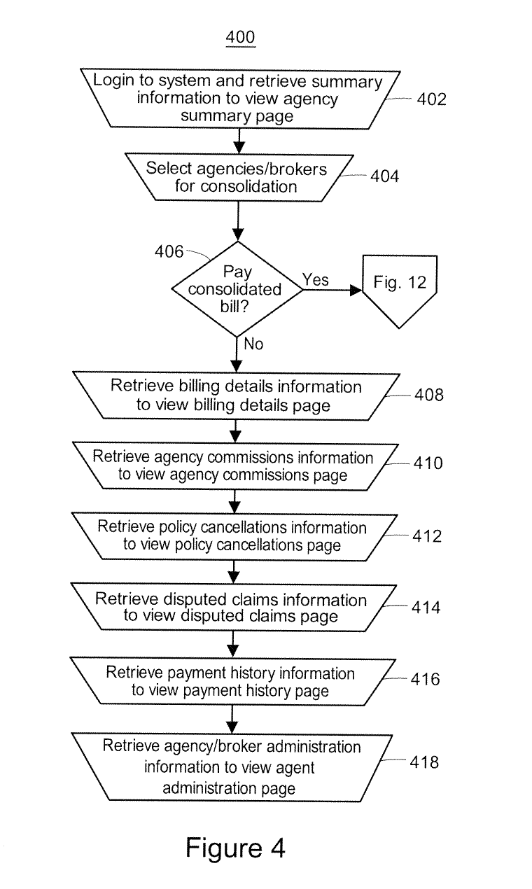

FIG. 4 is a flow diagram of an example method 400 for retrieving and editing data corresponding to invoices for agencies, agency/broker codes, and other entities for payment of the invoices and management of billing issues. The method 400 may include one or more blocks, modules, functions or routines in the form of computer-executable instructions that are stored in a tangible computer-readable medium and executed using a processor of a computing device (e.g., a personal computer, a network workstation, a server, a smart phone, tablet computer, or a mobile computing device, or other type of computing device). The method 400 may be included as part of any system 100 or computing device modules of a computing environment for the system 100 for producing consolidated agency invoices, for example, or as part of a module that is external to such a system. The method 400 may be part of an agency bill pay module 118 executing within an application on a computing device of the system 100 or as a module of a computing device accessing the system 100. FIG. 4 will be described with reference to the Figures for ease of explanation, but the method 400 can of course be utilized with other objects and user interfaces.

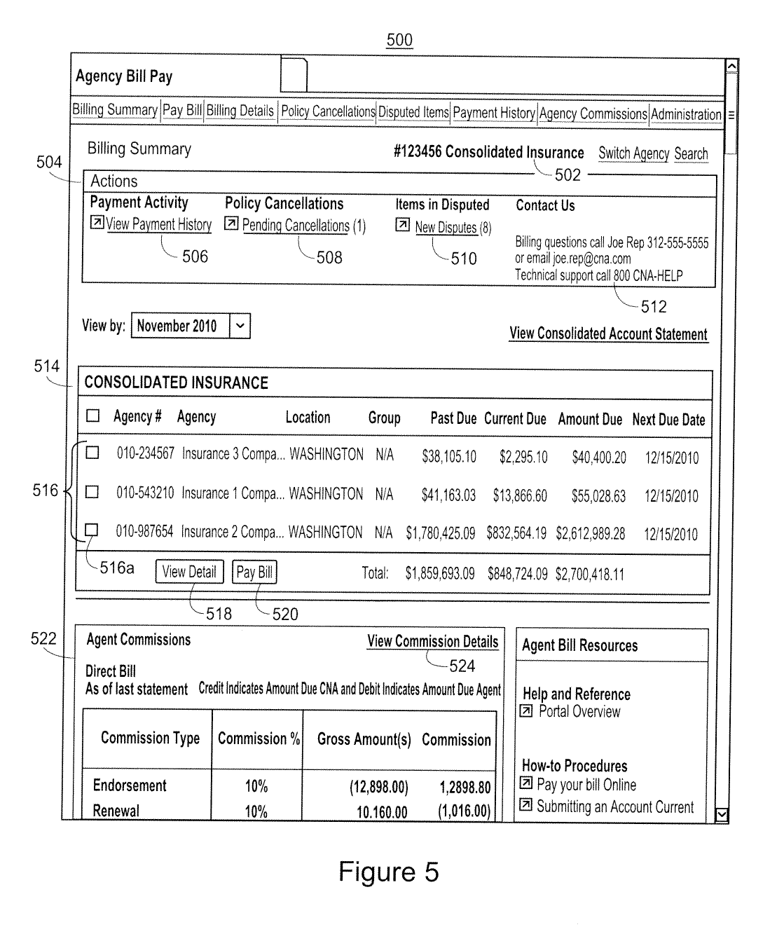

At block 402, the agency bill pay module 118 may execute instructions to allow a user or administrator of the system 100 to access the website 102. In some embodiments, the website may access login module to provide login data 116a defining permissions for the user. For example, the login data 116a may indicate particular data that the user may access (e.g., data for specific agencies, agency/broker codes, etc.). The agency bill pay module 118 may also execute instructions to extract billing data from a repository 120 corresponding to each of the plurality of agency/broker codes corresponding to the agency as well as summary information from another repository 120 and other components of the system. The data retrieved from the system 100 may correspond to permissions defined by the login data 116a. For example, if the login data 116a includes permissions for the agency Consolidated Insurance, then the information displayed by the website 102 for that login data 116a (as illustrated by FIG. 5) may include agency/broker code and insured information corresponding to Consolidated Insurance.

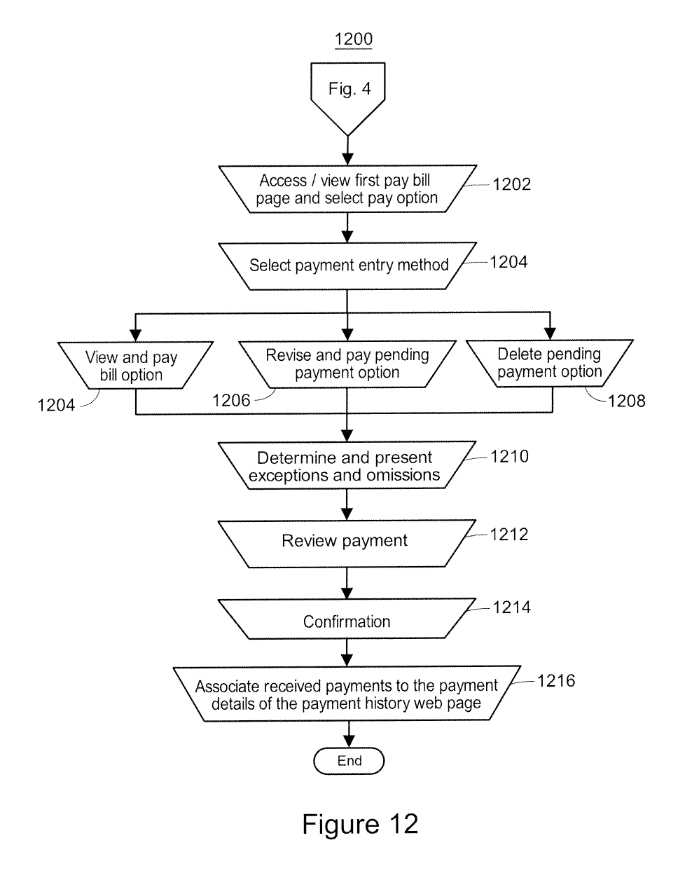

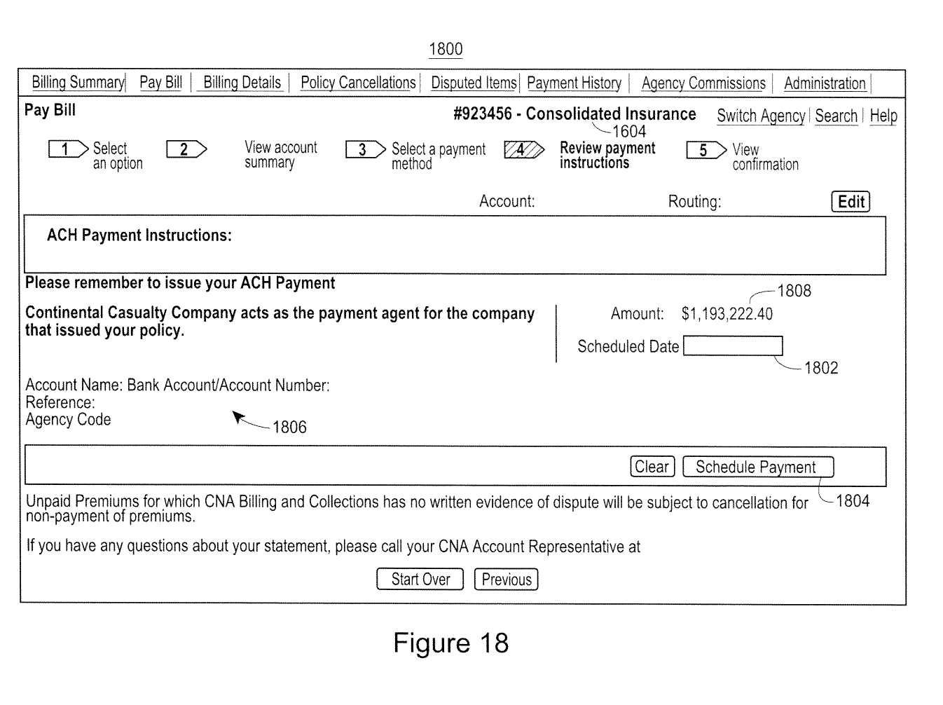

The agency bill pay module 118 may retrieve a summary page 500 (FIG. 5) and other data and instructions for a particular agency 502 as defined by the login data 116a. The summary page 500 may include an actions section 504 from which a user may cause the system 100 to execute instructions to view a payment history 506, cancellation information 508, dispute items 510, or contact information 512. A agency/broker code summary section 514 may include summary information for a plurality of agency/broker codes 516 corresponding to the agency 502. At block 404, the user may cause the module to consolidate one or more agency/broker codes 516 into a consolidated statement 122 for the agency 502 from the agency/broker code summary section 514. In some embodiments, summary page includes a graphic element 516a that corresponds to each agency/broker code 516 of the agency 502. The user may select one or more of the agency/broker codes 516 from a checkbox 516a or other graphic element of the summary page 500 that corresponds to a particular agency/broker code 516. The user may also cause the module 118 to execute instructions to view detail 518 and initiate bill payment 520 for selected agency/broker codes 516. For example, if the user selects the pay bill element 520 at block 406, the module 118 may initiate a function call to the module 118 and one or more functions 118a. The function call may include consolidation data 150 that indicates which of the plurality of agency/broker codes 516 the user selected from the checkbox 516a or other graphic element of the summary page 500. The called function may then execute instructions to retrieve the selected data corresponding to the consolidation data 150 from one or more data repositories 120. Selecting the one or more graphic elements 516a corresponding to particular agency/broker codes 516 of the agency 502, sending the consolidation data 150 to the agency bill pay module 118, and causing the module 118 to execute instructions to initiate bill payment may open a new set of web pages, as described below in relation to FIGS. 12-19. The summary page 500 may also include an agent commissions summary 522 for particular types of commissions that are attributable to the agency 502. A user may also cause the module 118 to execute instructions to view commission details 524.

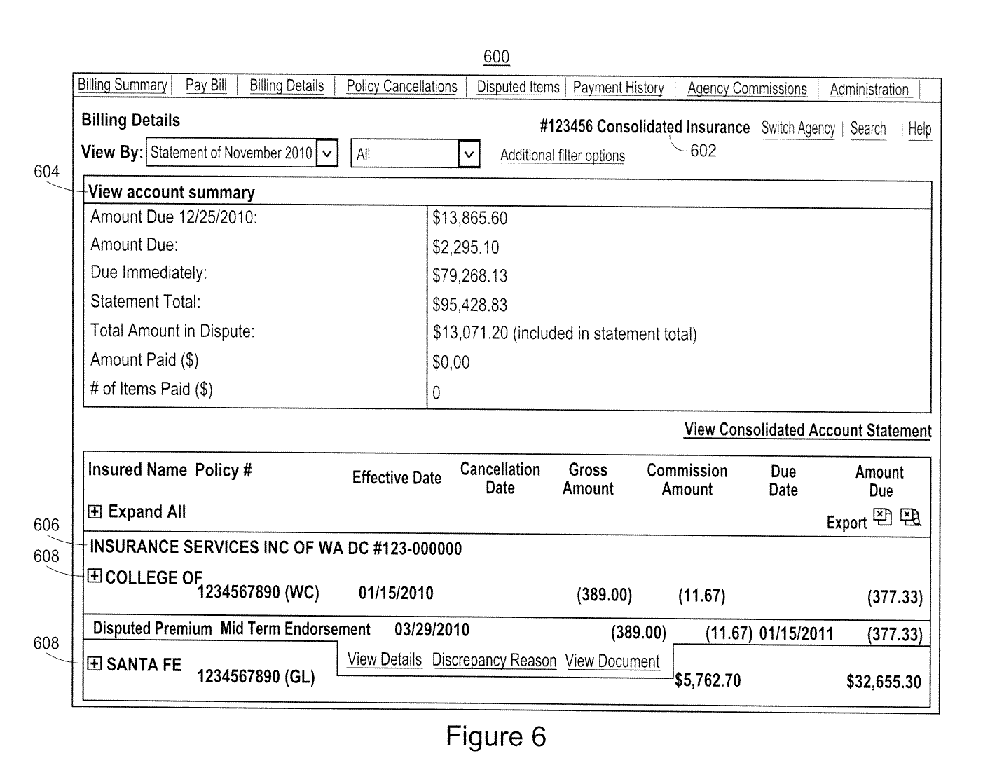

At block 408, a user may cause the agency bill pay module 118 to execute instructions to retrieve a billing details page 600 (FIG. 6) for an agency 602 defined by the user's login data 116a. For example, the agency bill pay module 118 may execute instructions to extract billing details information 604 from one or more data repositories 120 and other components of the system. Billing details information 604 may be filtered by various time periods (e.g., monthly, quarterly, etc.) and display billing information about the agency 602. For example, the billing information within the billing details page 600 may include an amount due, an amount due immediately, the statement total for the selected time period, an amount in dispute, an amount paid for the time period, a number of items paid, etc. Billing details may also be displayed for each agency/broker code 606 of the agency 602 and each insured 608 for the agency/broker code 606. In some embodiments, the details for each agency/broker code 606 for the insured 608 includes a name, policy number, policy effective date, cancellation date, gross amount, commission amount, due date, amount due, etc.

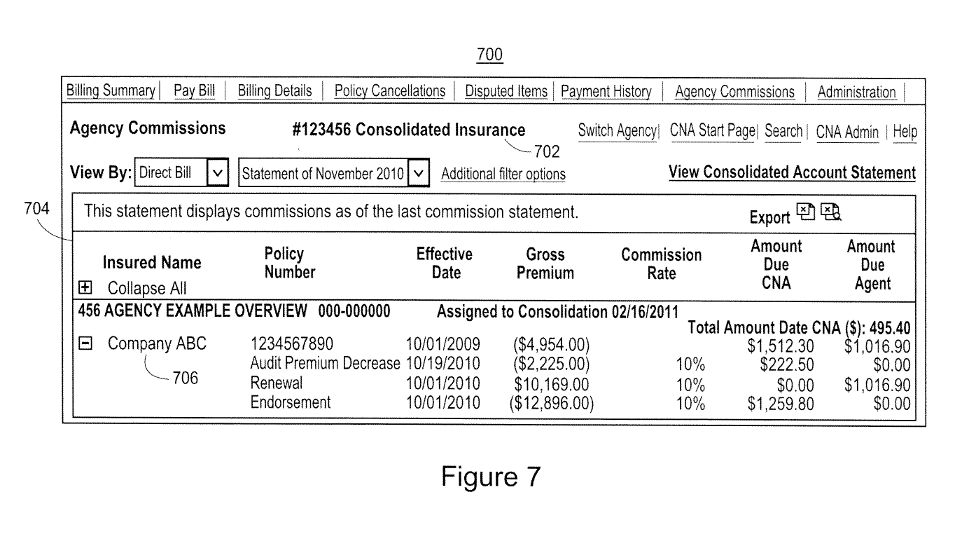

At block 410, a user may cause the agency bill pay module 118 to execute instructions to retrieve an agency commissions page 700 (FIG. 7) for an agency 702 defined by the user's login data 116a. For example, the agency bill pay module 118 may execute instructions to extract agency commissions information 704 from the one or more data repositories 120 and other components of the system. Agency commission information 704 may be filtered by various time periods (e.g., monthly, quarterly, etc.) and display commission information about the agency 702. In some embodiments, the information 704 is displayed as of the last commission statement. In some embodiments, the agency bill pay module 118 may execute instructions to display the commission information 704 according to each agency/broker code and each insured 706.

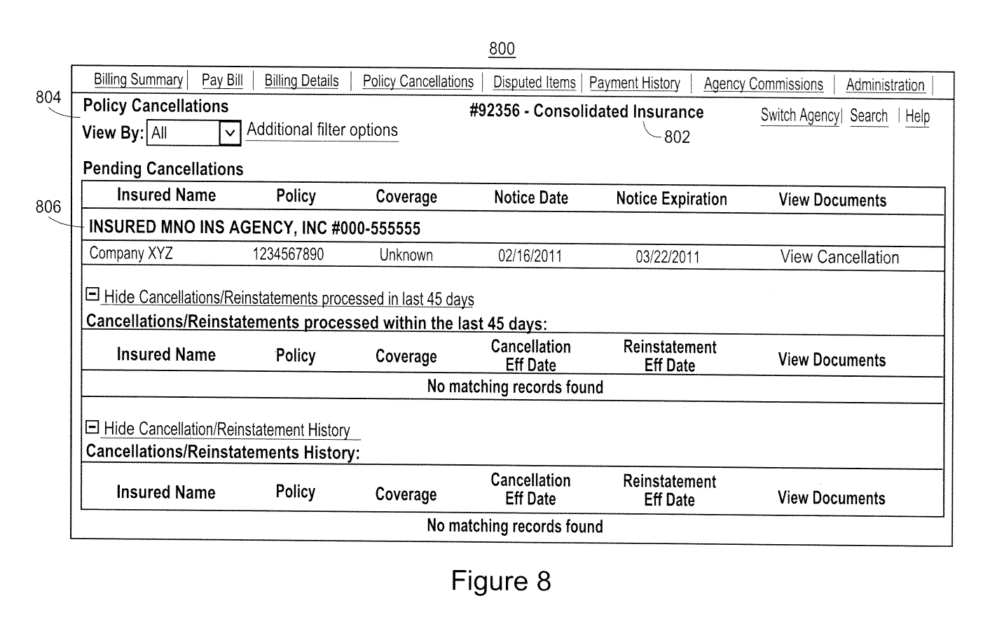

At block 412, a user may cause the agency bill pay module 118 to execute instructions to retrieve a policy cancellations page 800 (FIG. 8) for an agency 802 defined by the user's login data 116a. For example, the agency bill pay module 118 may execute instructions to extract policy cancellations information 804 from one or more data repositories 120 and other components of the system. Policy cancellations information 804 may be filtered by various time periods (e.g., monthly, quarterly, etc.) and display cancellation information for the agency 802. In some embodiments, the policy cancellations page 800 may display cancellation information for the agency corresponding to the agency's insured 806. The cancellation information 804 may include pending cancellations, cancellations/reinstatements processed within a time period, and a cancellations/reinstatements history, to name a few types of information that may be displayed within the page 800.

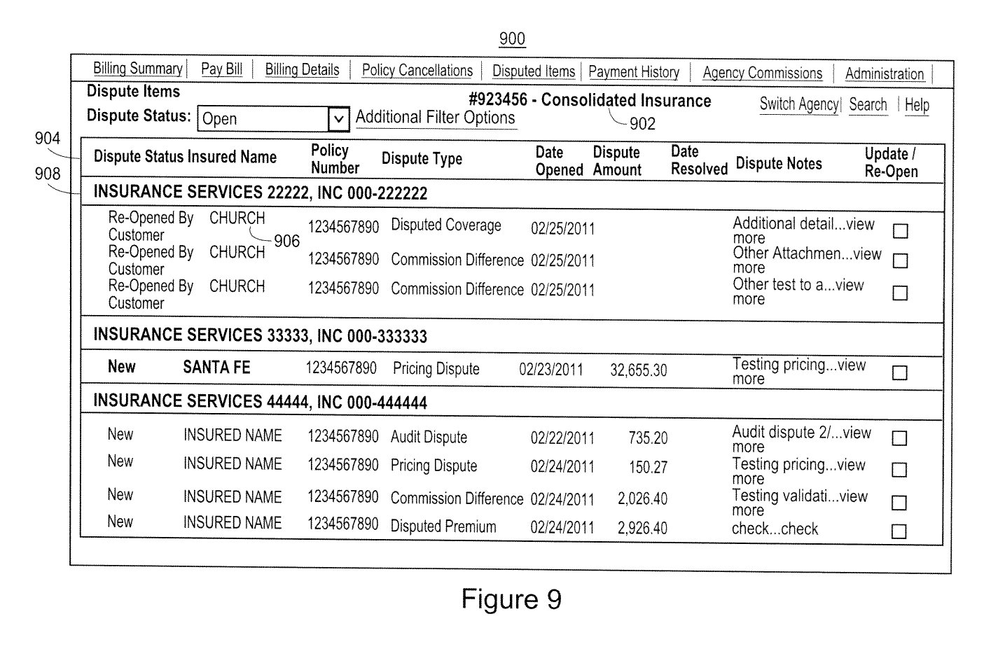

At block 414, a user may cause the agency bill pay module 118 to execute instructions to retrieve a disputed items page 900 (FIG. 9) for an agency 902 defined by the user's login data 116a. For example, the agency bill pay module 118 may execute instructions to extract disputed items information 904 from one or more data repositories 120 and other components of the system. Disputed items information 904 may be filtered by various statuses (e.g., open, closed, etc.) and displayed for each insured 906 corresponding to a agency/broker code 908 for the agency 902. The dispute items information 904 may include various data including a dispute status, an insured name, a policy number, a dispute type, a date opened, a disputed amount, a date resolved, dispute notes, etc. A user may also cause the module 118 to execute one or more functions 118a to initiate a dispute resolution process from the page 900.

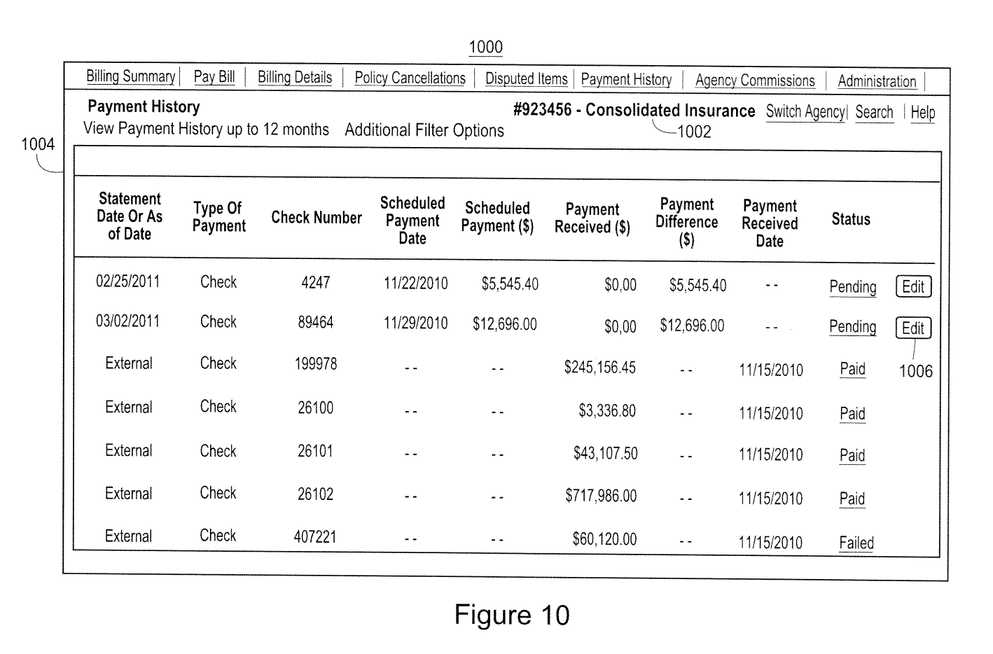

At block 416, a user may cause the agency bill pay module 118 to execute instructions to retrieve a payment history page 1000 (FIG. 10) for an agency 1002 defined by the user's login data 116a. For example, the agency bill pay module 118 may execute instructions to extract payment history information 1004 from one or more data repositories 120 and other components of the system. Payment history information 1004 retrieved from the system 100 and displayed on the website 102 may include a statement or “as of” date, a type of payment, a check number, a scheduled payment data, a scheduled payment amount, a payment received, a payment difference, a payment received date, etc. The payment history page 1000 may also allow a user or administrator with certain permissions defined in the login data 116a to initiate instructions that are executed by the system to edit 1006 the payment history.

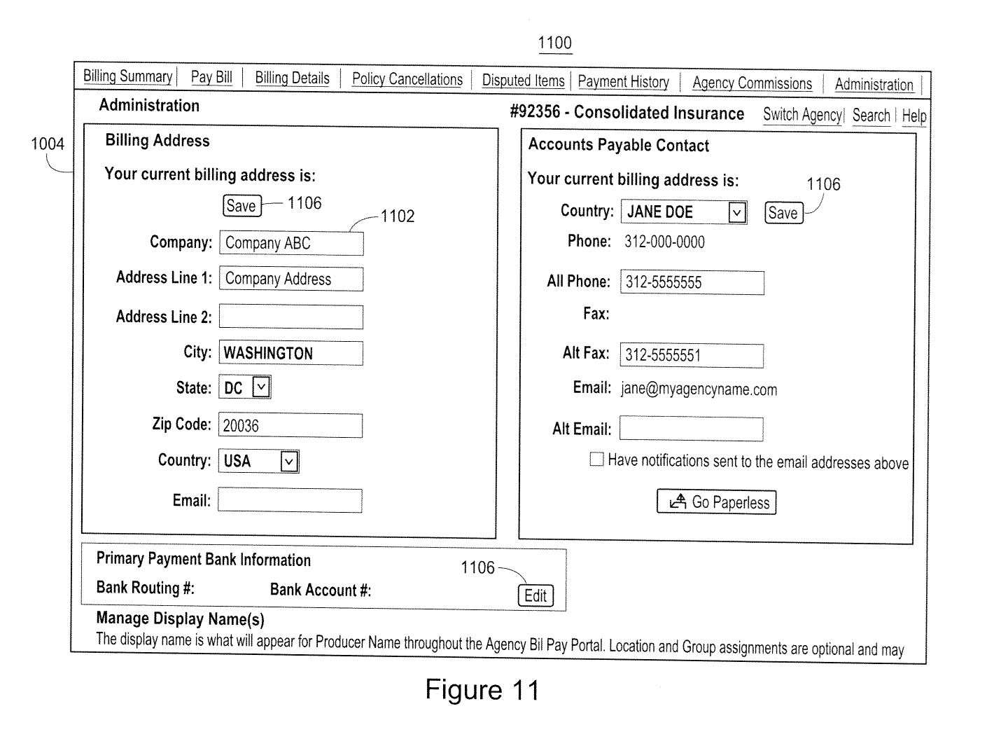

At block 418, a user may cause the agency bill pay module 118 to execute instructions to retrieve an administration page 1100 (FIG. 11) for an agency 1102 defined by the user's login data 116a. For example, the agency bill pay module 118 may execute instructions to extract administrative information 1004 from one or more data repositories 120 and other components of the system. The administration page 1100 may also allow a user or administrator with certain permissions defined in the login data 116a to initiate instructions to cause the system 100 to edit and save 1106 new administration data.

FIG. 12 is a flow diagram of an example method 1200 for paying consolidated invoices in an agency business model using a system 100 that permits consolidation of an agency's agency/broker code invoices into a single invoice as well as allowing a user to view accounts, reconcile discrepancies, and pay invoices using various payment methods, link to documentation for the account (e.g., policies, cancellations, audits, etc.), etc. The method 1200 may include one or more blocks, modules, functions or routines in the form of computer-executable instructions that are stored in a tangible computer-readable medium and executed using a processor of a computing device (e.g., a personal computer, a network workstation, a server, a smart phone, tablet computer, or a mobile computing device, or other type of computing device). The method 1200 may be included as part of the system 100 or computing device modules of a computing environment for the system 100 for producing consolidated agency invoices 254, for example, or as part of a module that is external to such a system. The method 1200 may be part of an agency bill pay module 118 executing within an application on a computing device of the system 100 or as a module of a computing device accessing the system 100. FIG. 12 will be described with reference to the Figures for ease of explanation, but the method 1200 can of course be utilized with other objects and user interfaces.

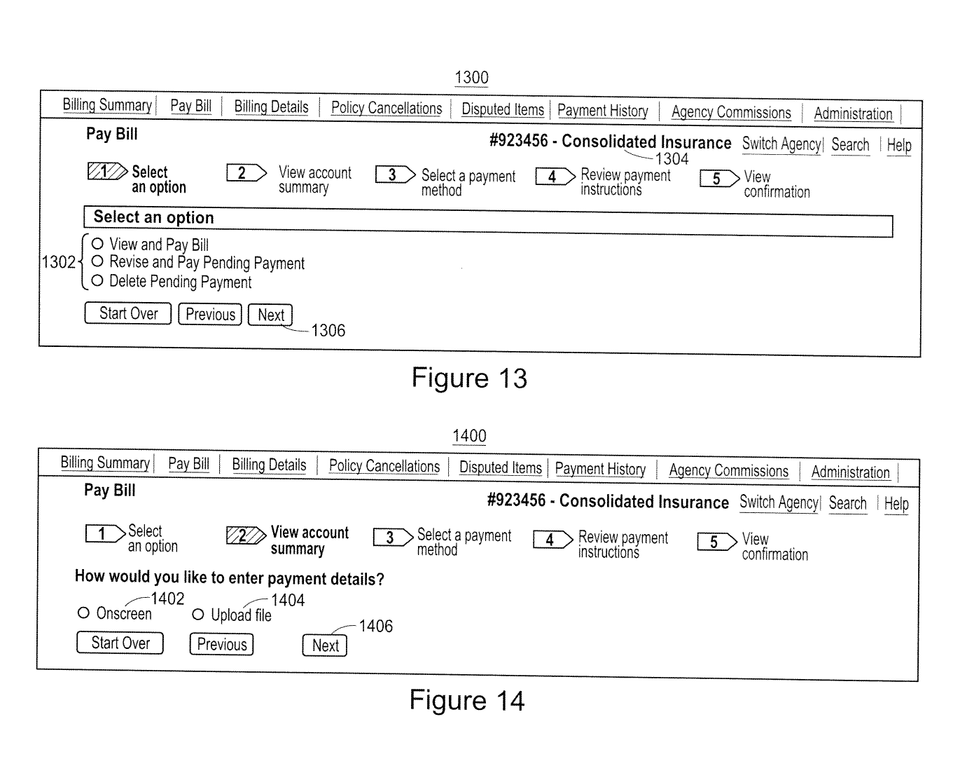

At block 1202, a user may cause the agency bill pay module 118 to execute instructions to retrieve a first pay bill page 1300 (FIG. 13) and select a bill payment option 1302 for an agency 1304 defined by the user's login data 116a and selected by the consolidation and related information viewing method described above in relation to FIG. 4. For example, the agency bill pay module 118 may execute instructions using data from the formatting data repository 114a to display the first bill pay page 1300. The first pay bill page 1300 may also allow a user to initiate instructions for the system 100 to perform various pay bill tasks 1302. In some embodiments, a first pay bill page 1300 allows a user to initiate instructions that cause the agency bill pay module 118 to retrieve and display data for viewing and paying a bill, revising and paying a pending payment, deleting a pending payment, etc. For example, the page 1300 may include a selectable graphic element 1306 that, when selected by a user, initiates a call to one or more functions 114b of the agency bill pay module 118. The function call from the selectable graphic element 1302 may include data from a selected pay bill task 1302 that causes one or more functions 114b to retrieve and launch a web page corresponding to a payment entry option 1400 (FIG. 14) and the selected task 1302.

At block 1204, the module 118 may execute instructions to retrieve a payment entry option page 1400. At the page 1400, a user may select from various options of accomplishing one or more of the tasks 1302 presented in the first pay bill page 1300. In some embodiments, the payment entry option page 1400 may present an onscreen option 1402 and an upload file option 1404. A user may select one of the options 1402, 1404, and then select another selectable graphic element 1406 to initiate a function call to execute a function 118a that allows the user to enter payment information in the selected format. If the user selected the upload file options 1404, then a user may submit a file including information describing invoice discrepancies, payment justification, and other information related to an invoice. For example, a user may revise a pending payment, then upload a spreadsheet or other file that explains the revision or presents other documentation to justify a payment that is different than an amount invoiced. In some embodiments, the uploaded file is in a particular format that may be processed and analyzed by instructions of the agency bill pay module 118. One or more functions 118a may determine that the justifications or other information included in the uploaded file are acceptable and apply a payment that is different than the invoiced amount to be applied to the user's account.

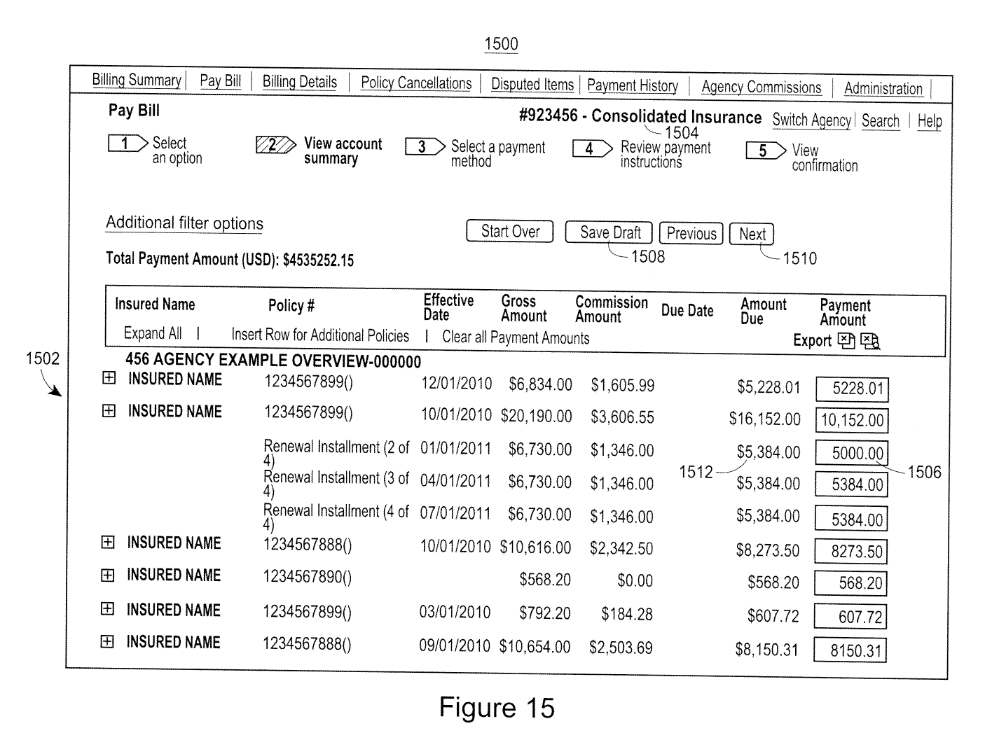

If the user selected a view and pay bill option at block 1202 and the onscreen option 1402 at block 1204, then the module 118 may execute instructions at block 1204 to retrieve and present a view account summary page 1500 (FIG. 15) including an account summary or “consolidation” 1502 of the insured corresponding to the agency 1504 agency/broker codes that were selected by the module 118 with reference to FIG. 4, above, as indicated by the consolidation data 150. For each of the insured, a user may enter a payment amount 1506. The user may also select a selectable graphic element 1508 that initiates a function call to one or more functions 118a to save a draft of the payment information 1506 for the consolidation 1502. The user may also select another selectable graphic element 1510 that initiates a function call to one or more functions 118a to retrieve and present web pages that allow the user to finalize any entered payments 1506.

If the user selected a “revise and pay a pending payment” option at block 1202 and the onscreen option 1402 at block 1204, then the module 118 may execute instructions at block 1206 to retrieve payment 1506 and a consolidation 1502 corresponding to the consolidation data 150 that was stored using functions associated with the save draft graphic element 1508, as described above. For each of the insured, a user may revise a payment amount 1506. The user may then select the selectable graphic element 1508 to initiate the function call to one or more functions 118a to present web pages that allow the user to finalize any entered payments 1506.

If the user selected a delete a pending payment option at block 1202 and the onscreen option 1402 at block 1204, then the module 118 may execute instructions at block 1208 to retrieve payment 1506 and a consolidation 1502 that was stored using functions associated with the save draft graphic element 1508, as described above. For each of the insured, a user may delete a payment amount 1506. The user may then select the selectable graphic element 1508 to initiate the function call to one or more functions 118a to present web pages that allow the user to finalize any entered payments 1506.

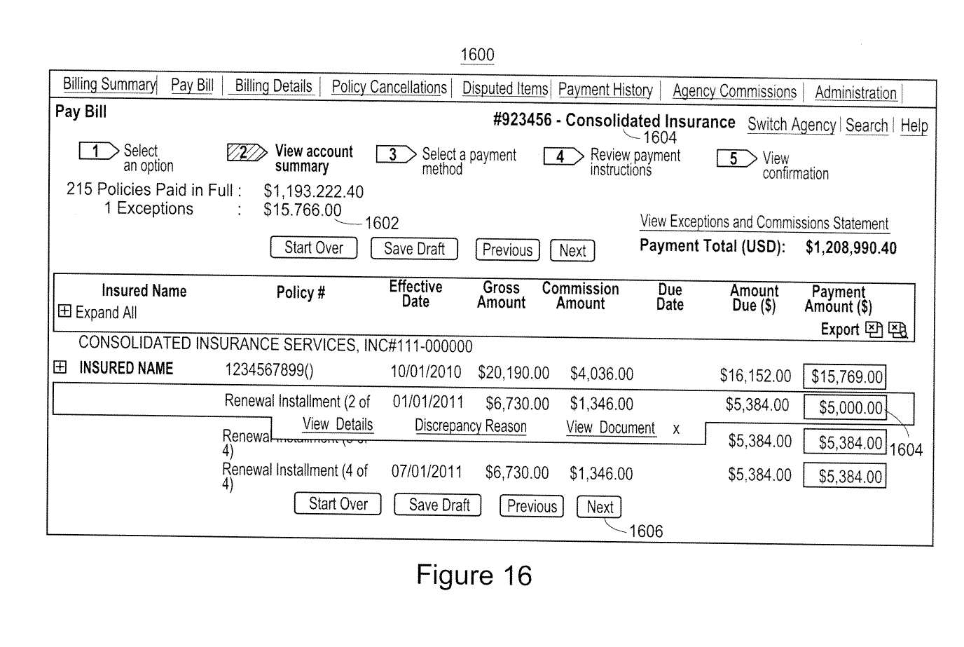

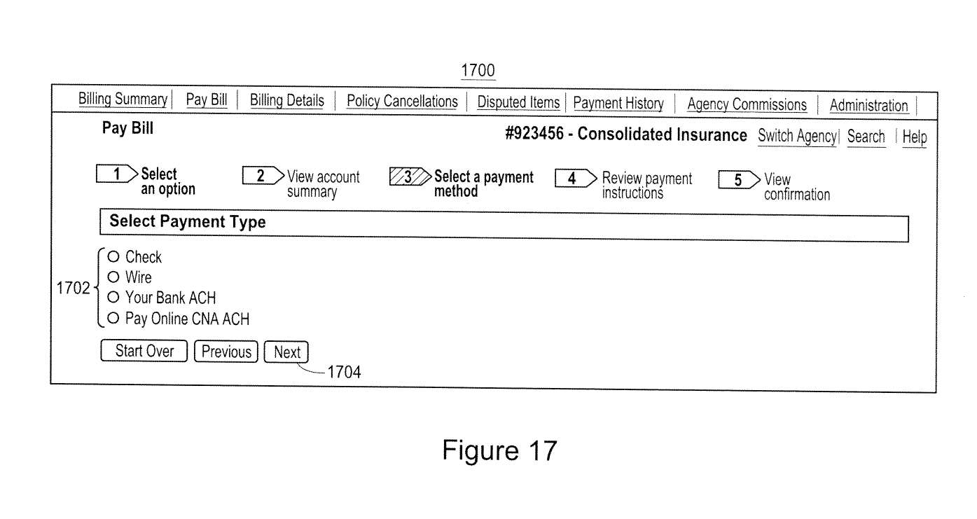

After selecting the selectable graphic element 1508, the module 118 may execute instructions at block 1210 to compare a payment amount 1506 and an amount due 1512 (FIG. 15) to determine any discrepancy between the amounts. If there is a discrepancy, then block 1210 may retrieve and present an exceptions and omissions page 1600 (FIG. 16). The page 1600 may include exceptions and omissions data 1602 when the block 1210 determines a discrepancy as well as the individual payment amounts 1604 that combine to generate the total discrepancy. At the exceptions and omissions page 1600, the user may revise payment amounts 1604 to correct the discrepancy. The user may also select a selectable graphic element 1606 to initiate a function call to continue finalizing the payment. If the exception or omission 1602 has not been corrected when the selectable graphic element 1606 is selected, then a function call to the module 118 may send data and instructions to a module of the system 100 to begin a collections process with the exception or omission 1602. If the exception or omission 1602 has been corrected when the selectable graphic element 1606 is selected, then a function call to the module 118 may retrieve and present a select payment method web page 1700 (FIG. 17). The page 1700 may include one or more selectable payment options 1702. After selecting a payment option 1702, the user may select another selectable graphic element 1704 to initiate the function call to one or more functions 118a to present further web pages that allow the user to finalize any entered payments.

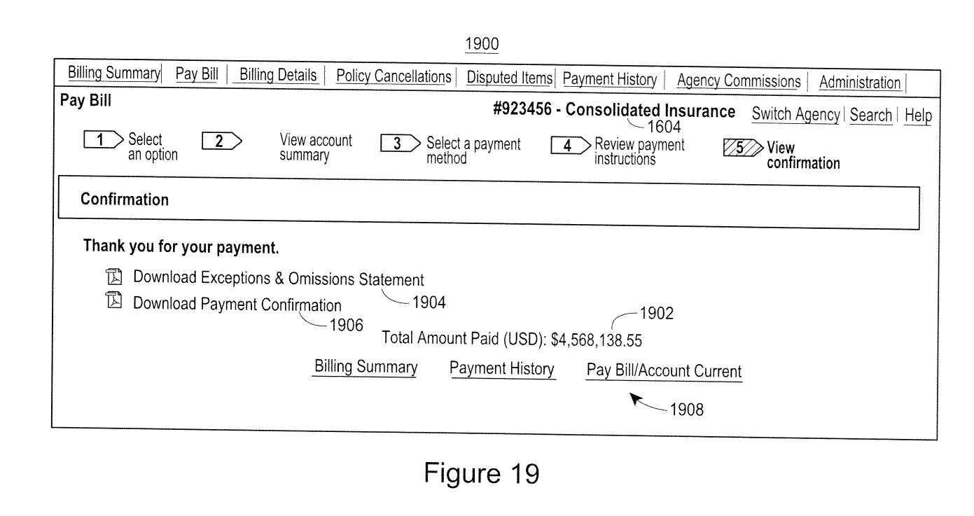

Selecting the selectable graphic element 1704 may initiate a function call to one or more functions 118a to execute instructions at block 1212 to retrieve and present a review payment instructions page 1800 (FIG. 8) to allow the user to review a just-completed payment. The review payment instructions page 1800 may include data and instructions to allow the user to initiate one or more functions to enter a payment date 1802, schedule a payment, and review account and payment information 1806. A selectable graphic element 1804 may allow a user to initiate a function 114a to save the payment date 1802. Upon fulfillment of the payment date 1802, the module 118 may execute instructions to communicate with a bank server 128a and complete an ACH/EFT transaction with the bank 128 for a payment amount 1806. Selecting the schedule payment selectable graphic element 1804 may also initiate a function call to one or more functions 118a to retrieve and present a view confirmation web page 1900 (FIG. 19).

The view confirmation web page 1900 may include payment data 1902 and various selectable graphic elements 1904, 1906, and 1908. In some embodiments, a selectable graphic element 1904 may, if selected, initiate one or more functions 118a to query the data repositories 120 to create a statement of exceptions and omissions, as described above. Another selectable graphic element 1906 may, if selected, initiate one or more functions 118a to query other data repositories 120 to create a statement of the payment, as also described above. Further selectable graphic elements 1908 may, if selected, initiate one or more functions 118a to display a billing summary, a payment history, or pay another bill. Once paid, at block 1216, the system 100 may automatically associate multiple types of payments received from agents and brokers (e.g., checks, wires, ach, online submission, etc.) to the payment details shown in the payment history web page 1000 where the payments were submitted using functions that were activated within in the Pay Bill screens (FIGS. 13-19). Payments may be automatically associated with the payment details regardless of whether the payment is received within the system 100 or external to the system 100.

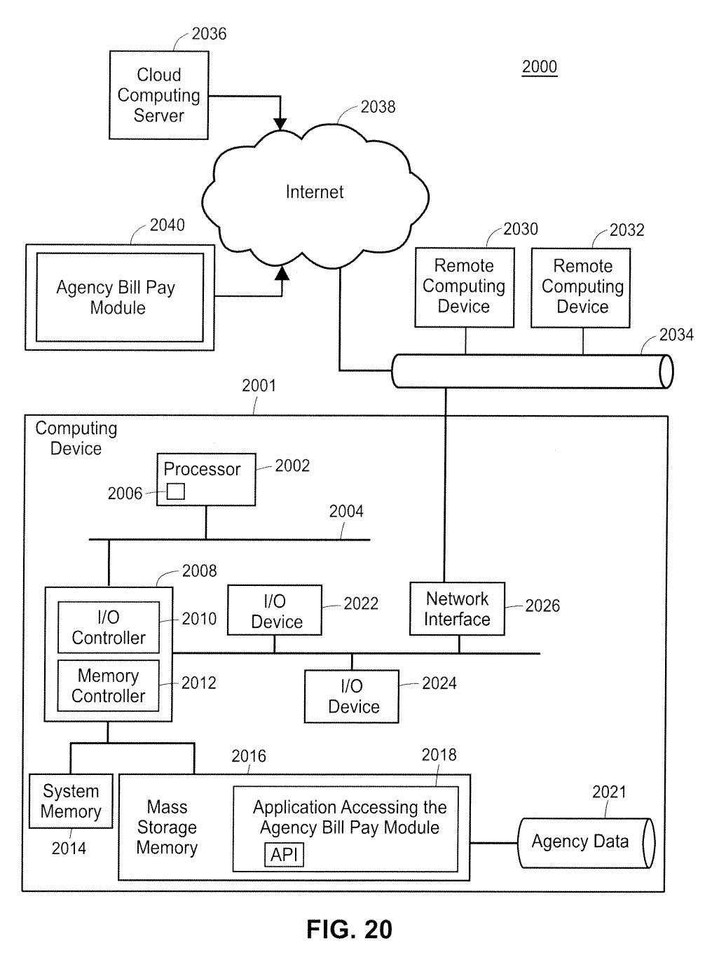

FIG. 20 is a high-level block diagram of an example computing environment for payment system 2000 for an agency business model having a computing device 2001 that may be used to implement the methods 400 and 1200 for consolidating multiple agency/broker code invoices into a single invoice for an agency or into multiple groupings (“consolidations”) that align with the agency's accounting needs, to view account information, reconcile account discrepancies, and make account payments, to access account documentation, to implement various payment methods, etc., as described herein. The computing device 2001 may include a personal computer, server, mobile computing device (e.g., a cellular phone, tablet computers, a Wi-Fi-enabled device or other personal computing device capable of wireless or wired communication), a thin client, or other known type of computing device. As will be recognized by one skilled in the art, in light of the disclosure and teachings herein, other types of computing devices can be used that have different architectures. Processor systems similar or identical to the example payment system 2000 may be used to implement and execute the example system of FIG. 1, payment processes of FIGS. 2a and 2b, the methods of FIGS. 4 and 12, the web pages of FIGS. 5-11 and 13-19, etc. Although the example payment system 2000 is described below as including a plurality of peripherals, interfaces, chips, memories, etc., one or more of those elements may be omitted from other example processor systems used to implement and execute the example system 2000 to consolidate multiple agency/broker code invoices, view account information, reconcile discrepancies, make payments, etc.

As shown in FIG. 2000, the computing device 2001 includes a processor 2002 that is coupled to an interconnection bus 2004. The processor 2002 includes a register set or register space 2006, which is depicted in FIG. 20 as being entirely on-chip, but which could alternatively be located entirely or partially off-chip and directly coupled to the processor 2002 via dedicated electrical connections and/or via the interconnection bus 2004. The processor 2002 may be any suitable processor, processing unit or microprocessor. Although not shown in FIG. 20, the computing device 2001 may be a multi-processor device and, thus, may include one or more additional processors that are identical or similar to the processor 2002 and that are communicatively coupled to the interconnection bus 2004.

The processor 2002 of FIG. 20 is coupled to a chipset 2008, which includes a memory controller 2010 and a peripheral input/output (I/O) controller 2012. As is well known, a chipset typically provides I/O and memory management functions as well as a plurality of general purpose and/or special purpose registers, timers, etc. that are accessible or used by one or more processors coupled to the chipset 2008. The memory controller 2010 performs functions that enable the processor 2002 (or processors if there are multiple processors) to access a system memory 2014 and a mass storage memory 2016.

The system memory 2014 may include any desired type of volatile and/or non-volatile memory such as, for example, static random access memory (SRAM), dynamic random access memory (DRAM), flash memory, read-only memory (ROM), etc. The mass storage memory 2016 may include any desired type of mass storage device. For example, if the computing device 2001 is used to implement a web browser or other application 2018 accessing an agency bill pay module 2019 having an API (including the blocks, functions, instructions, etc., as described by the methods 400 and 1200 of FIGS. 4 and 12, respectively), the mass storage memory 2016 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 2001 and the payment system 2000. Thus, a module, block, function, operation, procedure, routine, step, and method can be implemented in hardware, firmware, and/or software. In one embodiment, program modules and routines (e.g., the application 2018 accessing agency bill pay module 2019, the API, etc.) are stored in mass storage memory 2016, loaded into system memory 2014, and executed by a processor 2002 or can be provided from computer program products that are stored in tangible computer-readable storage mediums (e.g. RAM, hard disk, optical/magnetic media, etc.). Mass storage 2016 may also include a database 2021 storing agency data, billing and commissions data, graphics, and other data for use by the agency bill pay module 2019 and application 518 as well as a database interface module through which the module 2019, the API, the application 2018, etc., may access the agency data, graphics, etc. received from a system 100 for consolidating billing, policy, and collections information within a single web portal or website 102, or other system.

The peripheral I/O controller 2010 performs functions that enable the processor 2002 to communicate with peripheral input/output (I/O) devices 2022 and 2024, a network interface 2026 via a peripheral I/O bus 2028. The I/O devices 2022 and 2024 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O devices 2022 and 2024 may be used with the application 2018 and module 2019 to receive agency data, consolidations, billing and collections data, etc., send selections, administrative data, and payment data to the backend components of the payment system 2000, render, and display consolidations, payments, exceptions and omissions, web pages, and user interfaces as described in relation to the figures.

While the memory controller 2012 and the I/O controller 2010 are depicted in FIG. 20 as separate functional blocks within the chipset 2008, the functions performed by these blocks may be integrated within a single integrated circuit or may be implemented using two or more separate integrated circuits. The payment system 2000 may also implement the agency bill pay module 2019 on remote computing devices 2030 and 2032. The remote computing devices 2030 and 2032 may communicate with the computing device 2001 over an Ethernet link 2034. For example, the computing device 2001 may receive agency and consolidation data created by the agency bill pay module executing on a remote computing device 2030, 2032. In some embodiments, the module 2019 may be accessed or retrieved by the computing device 2001 from a cloud computing server 2036 via the Internet 2038. When using the cloud computing server 2036, the retrieved module 2019 may be programmatically linked with the computing device 2001. The module 2019 may be a Java® applet executing within a Java® Virtual Machine (JVM) environment resident in the computing device 2001 or the remote computing devices 2030, 2032. The agency bill pay module 2019 and/or the application 2018 accessing the module 2019 may also be a “plug-in” adapted to execute in a web-browser located on the computing devices 2001, 2030, and 2032. In some embodiments, the agency bill pay module may communicate with back end components 2040 such as the system 100 via the Internet 2038.

Using the systems and procedures described above, the system 500 may consolidate an agency's multiple agency/broker code invoices into one invoice for the agency or multiple groupings (consolidations) that align with the agency's accounting needs. Furthermore, the customer-focused, web-based computer system 500 may put the agency and the agency/broker code's perspective into billing, collections, and cash application processes. The system may also allow the carrier to manage relationships with agents. Furthermore, the system may include linkage to policy documents, a consolidated agency/broker code bill and commission presentment, online account reconciliation, and automated payment application. The system may also reduce paper-based transactions.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the system 500 may include but is not limited to any combination of a LAN, a MAN, a WAN, a mobile, a wired or wireless network, a private network, or a virtual private network. Moreover, while only three remote computing devices 530 and 532 are illustrated in FIG. 5 to simplify and clarify the description, it is understood that any number of client computers are supported and can be in communication within the system 500.

Additionally, certain embodiments are described herein as including logic or a number of components, modules, or mechanisms. Modules may constitute either software modules (e.g., code embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a map editor system for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for consolidating multiple invoices corresponding to agencies and brokers of an insurance agency into a consolidated agency invoice for the agency/broker, the method comprising:
receiving login data including agency permissions to access billing data corresponding to a plurality of agency/broker codes for the agency;
receiving consolidation data corresponding to at least one of the agency/broker codes, the consolidation data indicating which of the plurality of agency/broker code codes to include on a consolidated agency invoice;
retrieving billing data corresponding to the indicated agency/broker codes from the consolidation data; and
displaying the retrieved billing data in the consolidated agency invoice.

2. The computer-implemented method of claim 1, wherein the retrieved billing data includes a plurality of insured corresponding to each of the plurality of agency/broker codes.

3. The computer-implemented method of claim 1, wherein displaying the retrieved billing data in the consolidated agency invoice includes displaying a selectable graphic element to view one or more of payment history, cancellation information, dispute items, transactional billing documents, and contact information corresponding to the retrieved billing data.

4. The computer-implemented method of claim 1, further comprising displaying billing data corresponding to the agency/broker codes of the agency in response to receiving the login data.

5. The computer-implemented method of claim 1, wherein displaying the retrieved billing data in the consolidated agency invoice includes generating one or more of a web page including the retrieved billing data or a paper invoice including the retrieved billing data.

6. The computer-implemented method of claim 5, wherein the web page for the consolidated agency invoice includes instructions that allow a user to retrieve, upload and display data for viewing and paying a bill online or offline, for revising and paying a pending payment, and for deleting a pending payment.

7. The computer-implemented method of claim 6, wherein the data corresponds to the retrieved billing data.

8. The computer-implemented method of claim 1, further comprising comparing a payment amount and an amount due corresponding to the consolidated agency invoice to determine a discrepancy.

9. The computer-implemented method of claim 8, further comprising retrieving and displaying an exceptions and omissions web page in response to determining the discrepancy between the payment amount and the amount due corresponding to the consolidated agency invoice.

10. A tangible computer-readable medium storing instructions for consolidating multiple agency/broker invoices corresponding to an insurance agency into a consolidated agency invoice, the instructions when executed by a processor cause the processor to:
receive login data including agency permissions to access billing data corresponding to a plurality of agency/broker codes for the agency;
receive consolidation data corresponding to at least one of the agency/broker codes, the consolidation data indicating which of the plurality of agency/broker codes to include on a consolidated agency invoice;
retrieve billing data corresponding to the indicated agency/broker codes from the consolidation data; and
format and present the retrieved billing data in the consolidated agency invoice.

11. The tangible computer-readable medium of claim 10, wherein the retrieved billing data includes a plurality of insured corresponding to each of the plurality of agency/broker codes.

12. The tangible computer-readable medium of claim 10, wherein the instruction to present the retrieved billing data in the consolidated agency invoice includes and instruction to present a selectable graphic element to view one or more of payment history, cancellation information, dispute items, and contact information corresponding to the retrieved billing data.

13. The tangible computer-readable medium of claim 10, further comprising an instruction to present billing data corresponding to the agency/broker codes of the agency in response to receiving the login data.

14. The tangible computer-readable medium of claim 10, wherein the instruction to format and present the retrieved billing data in the consolidated agency invoice for the agency includes an instruction to generate one or more of a web page including the retrieved billing data as the consolidated agency invoice or a paper invoice including the retrieved billing data as the consolidated agency invoice, wherein the web page for the consolidated agency invoice includes instructions that allow a user to retrieve and display data for viewing and paying a bill, for revising and paying a pending payment, and for deleting a pending payment, and the data corresponds to the retrieved billing data.

15. The tangible computer-readable medium of claim 12, further comprising an instruction to automatically associate completed payments to the payment history, wherein the completed payments include one or more of a check, a wire payment, an ACH payment, or and online payment.

16. A computer system for consolidating multiple agency/broker invoices corresponding to an insurance agency into a consolidated agency invoice, the system comprising:
a web portal that is executable by a server and configured to receive login data from a web browser over a network connection, the login data including agency permissions to access billing data corresponding to a plurality of agency/broker codes for the agency;
an data repository in communication with the server and storing the billing data corresponding to the plurality of agency/broker codes for the agency; and
an agency bill pay module that is executable by the server and configured to receive consolidation data via the web portal, the consolidation data corresponding to at least one of the agency/broker codes and indicating which of the plurality of agency/broker codes to include on a consolidated agency invoice, the agency bill pay module further configured to retrieve billing data corresponding to the indicated agency/broker codes from the consolidation data, format the retrieved billing data in the consolidated agency invoice, and present the consolidated agency invoice on the web browser via the network connection.

17. The computer system of claim 16, wherein the billing data retrieved by the agency bill pay module includes a plurality of insured corresponding to each of the plurality of agency/broker codes.

18. The computer system of claim 16, wherein the consolidated agency invoice includes one or more selectable graphic elements to present one or more of payment history, cancellation information, dispute items, and contact information corresponding to the retrieved billing data on the web browser via the network connection.

19. The computer system of claim 16, wherein the agency bill pay module is further configured to generate one or more of a web page including the retrieved billing data as the consolidated agency invoice or a paper invoice including the retrieved billing data as the consolidated agency invoice, wherein the web page for the consolidated agency invoice includes a selectable graphic element that allows a user to retrieve and display data for viewing and paying a bill, for revising and paying a pending payment, and for deleting a pending payment, and the data corresponds to the retrieved billing data.

20. The computer system of claim 16, wherein the agency bill pay module is further configured to compare a payment amount and an amount due corresponding to the consolidated agency invoice to determine a discrepancy and the agency bill pay module is still further configured to retrieve and present an exceptions and omissions web page on the browser via the network connection in response to determining the discrepancy between the payment amount and the amount due corresponding to the consolidated agency invoice.
